(19) United States
(12) Patent Application Publication
(10) Pub. No.: US 2019/0096403 A1
(43) Pub. Date: Mar. 28, 2019

(54) SERVICE PROVIDING DEVICE AND COMPUTER-READABLE NON-TRANSITORY STORAGE MEDIUM STORING SERVICE PROVIDING PROGRAM

(71) Applicant: TOYOTA JIDOSHA KABUSHIKI KAISHA, Toyota-shi (JP)

(72) Inventor: Koichi SUZUKI, Miyoshi-shi (JP)

(73) Assignee: TOYOTA JIDOSHA KABUSHIKI KAISHA, Toyota-shi (JP)

(21) Appl. No.: 16/126,519

(22) Filed: Sep. 10, 2018

(30) Foreign Application Priority Data
Sep. 27, 2017 (JP) 2017-186213

(51) Int. Cl. G10L 15/22; G10L 15/08; G10L 15/26; G06F 17/30

(52) U.S. Cl. CPC G10L 15/22; G10L 15/08; G10L 2015/225; G06F 17/30654; G10L 2015/221; G10L 15/265

(57) ABSTRACT

A service providing device includes a computer. The computer stores a plurality of input items needed when services based on voice recognition are provided and weighting factors for the input items, for each service. The computer specifies the input items in which uttered content is stored, based on the content uttered by the user. The computer stores the uttered content in the specified input item. The computer calculates a score of each service based on all the input items in which the uttered content is stored and the weighting factors corresponding to the input items. The computer requests a user to utter the input item when there is the input item in which the uttered content is not yet stored in the service having the highest calculated score.

### INCORPORATION BY REFERENCE

The disclosure of Japanese Patent Application No. 2017-186213 filed on Sep. 27, 2017 including the specification, drawings and abstract is incorporated herein by reference in its entirety.

### BACKGROUND

### 1. Technical Field

The present disclosure relates to a service providing device and a computer-readable non-transitory storage medium storing a service providing program.

### 2. Description of Related Art

Japanese Unexamined Patent Application Publication No. 2015-69103 (JP 2015-69103 A) discloses an information processing device that executes a voice search based on an input voice. In JP 2015-69103 A, in a case where conditions are insufficient with information input and acquired so far and the voice search cannot be executed when the voice search is executed, the user is questioned so as to obtain insufficient information and the information needed for the search is automatically supplemented.

### SUMMARY

In JP 2015-69103 A, a service to be provided by an information processing device is specified for a voice search. Therefore, a user does not need to designate a type of service when using the voice search. However, when there is a plurality of types of services to be provided to users, conditions needed for providing the services differ from service to service. In this case, when the user uses the service, the user needs to utter after designating the type of the service to be used, which is a factor of inconvenience for users.

The present disclosure provides a service providing device capable of further improving convenience for users and a computer-readable non-transitory storage medium storing a service providing program.

A first aspect of the present disclosure relates to a service providing device including a computer. The computer is configured to store a plurality of input items needed when services based on voice recognition are provided and weighting factors for the input items, for each service, specify the input items in which uttered content is stored, based on the content uttered by the user, store the uttered content in the specified input item, calculate a score of each service based on all the input items in which the uttered content is stored and the weighting factors corresponding to the input items, and request a user to utter the input item when there is the input item in which the uttered content is not yet stored in the service having the highest calculated score.

A second aspect of the present disclosure relates to a computer-readable non-transitory storage medium storing a service providing program. The service providing program causes a computer to store a plurality of input items needed when services based on voice recognition are provided and weighting factors for the input items, for each service, specify the input items in which uttered content is stored, based on the content uttered by the user, store the uttered content in the specified input item, calculate a score of each service based on all the input items in which the uttered content is stored and the weighting factors corresponding to the input items, and request a user to utter the input item when there is the input item in which the uttered content is not yet stored in the service having the highest calculated score.

According to the aspects of the present disclosure, it is possible to provide a service providing device capable of further improving convenience for users and a computer-readable non-transitory storage medium storing a service providing program.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a configuration of a service providing system including a service providing device according to an embodiment;

FIG. 2A is a diagram illustrating content of input item information that is stored in an input item information DB, and is a diagram illustrating content of input item information when a service is a scheduler; and

FIG. 2B is a diagram illustrating the content of the input item information that is stored in the input item information DB, and is a diagram illustrating content of input item information when the service is navigation (route search).

### DETAILED DESCRIPTION OF EMBODIMENTS

Preferred embodiments of the present disclosure will be described with reference to the accompanying drawings. In the respective drawings, units denoted with the same reference numerals have the same or similar configuration.

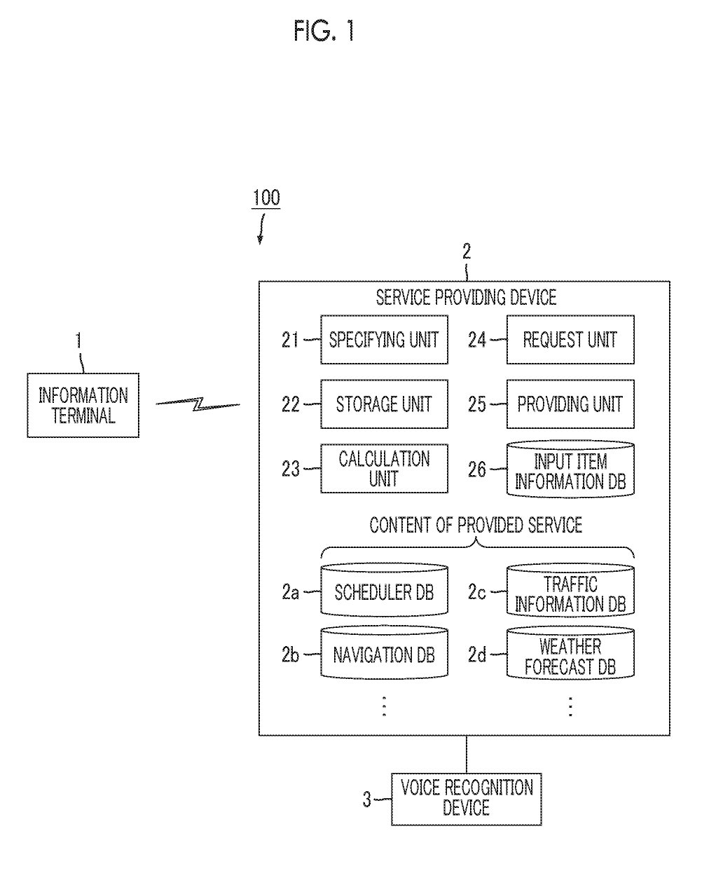

A configuration of a service providing system including a service providing device according to an embodiment will be described with reference to FIG. 1. The service providing system 100 includes an information terminal 1 that is used by a user, and a service providing device 2 and a voice recognition device 3 disposed in a data center or the like. The information terminal 1 and the service providing device 2, and the service providing device 2 and the voice recognition device 3 are configured to be able to communicate with each other over a network.

The network may be a wired network, may be a wireless network, or may be a combination of the wired network and the wireless network. In this embodiment, as an example, the wireless network is used between the information terminal 1 and the service providing device 2, and a wired network is used between the service providing device 2 and the voice recognition device 3.

The information terminal 1 illustrated in FIG. 1 is a tablet type terminal device including a mobile phone represented by a smartphone. The information terminal 1 includes, for example, a control unit including a central processing unit (CPU) and a memory, an operation unit, a display, a storage unit, and a communication unit as a physical configuration. Various functions incorporated in the information terminal 1 are realized by the CPU executing a predetermined program stored in the memory.

The service providing device 2 includes, for example, a specifying unit 21, a storage unit 22, a calculation unit 23, a request unit 24, and a providing unit 25 as a functional configuration. The service providing device 2 includes, for example, a control unit including a CPU and a memory, a storage device, and a communication device as a physical configuration. Respective functions of the specifying unit 21, the storage unit 22, the calculation unit 23, the request unit 24, and the providing unit 25 are realized by the CPU executing the predetermined program stored in the memory. Details of the respective functions will be described below.

An input item information database (DB) 26 stores input item information on input items needed when services based on voice recognition are provided, for each service. The service corresponds to, for example, a scheduler, navigation, traffic information, or weather forecast. Content needed when each service is provided is stored in a database of the service providing device 2. Examples of the database for storing the content include a scheduler DB 2a, a navigation DB 2b, a traffic information DB 2c, and a weather forecast DB 2d.

The input item information DB 26 includes, for example, an item name, a weighting factor, and an indispensability, as data items. The item name stores a name for specifying the input item. The weighting factor stores a coefficient for weighting the input item when a score to be described below is calculated. The indispensability stores information indicating whether or not an input to the input item is indispensable when the service is received.

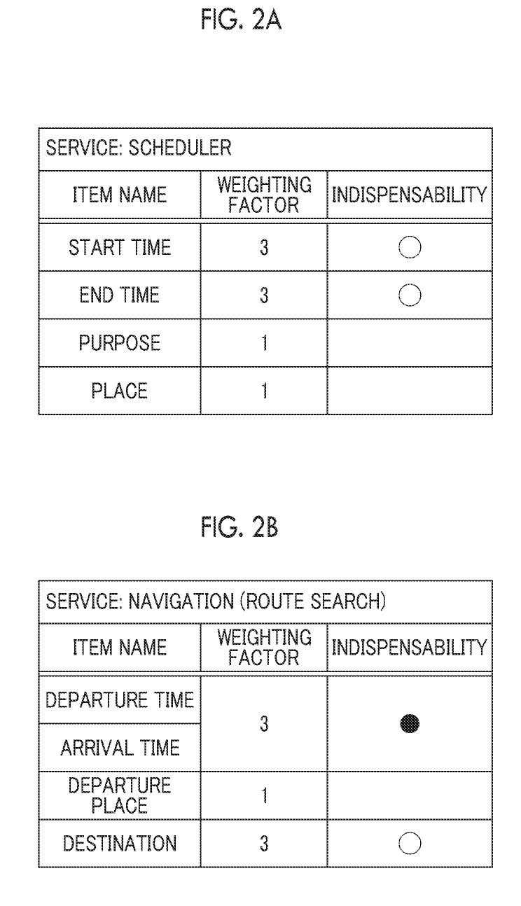

FIGS. 2A and 2B illustrate content of the input item information stored in the input item information DB 26. FIG. 2A illustrates content of the input item information when a service is a scheduler. FIG. 2B illustrates content of the input item information when the service is navigation (route search).

As illustrated in FIG. 2A, a start time, an end time, a purpose, and a place are set as item names that are items to be input when a scheduler service is received. “3” is set as a weighting factor for each of the start time and the end time. “1” is set as the weighting factor for each of the purpose and the place. The start time and the end time are set as items to which an input is indispensable when the scheduler service is received.

As illustrated in FIG. 2B, a departure time, an arrival time, a departure place, and a destination are set as item names that are items to be input when the navigation (route search) service is received. “3” is set as the weighting factor in each of the departure time, the arrival time, and the destination. “1” is set as the weighting factor in the departure place. The departure time, the arrival time, and the destination are set as items to which an input is indispensable when the navigation (route search) service is received. A mark “•” indicating whether or not the input item is indispensable, which is set in two or more item names, indicates that any one of the input items is an indispensable input item. FIG. 2B shows that an input to any one of the departure time and the arrival time is indispensable.

Refer back to the description of FIG. 1. Each function of the service providing device 2 will be described below.

The specifying unit 21 receives content uttered by the user (hereinafter also referred to as “uttered content”) from the information terminal 1 and specifies an input item in which the received uttered content is stored. Hereinafter, a procedure when the input item is specified will be specifically described.

First, the specifying unit 21 transmits a voice received from the information terminal 1 to the voice recognition device 3. The voice recognition device 3 analyzes the received voice, converts the voice into text, and transmits the text to the service providing device 2. The voice analysis can be performed using a known voice analysis scheme.

Subsequently, the specifying unit 21 determines a corresponding item name among the item names provided for each service based on the uttered content of the text received from the voice recognition device 3, and specifies the input item in which the uttered content is stored.

The storage unit 22 stores the uttered content in the input item specified by the specifying unit 21.

The calculation unit 23 calculates a score for each service based on all input items in which the uttered content has been stored and weighting factors corresponding to the input items. Hereinafter, a procedure of calculation of the score will be specifically described.

For example, when the uttered content of the user is “from 9 o'clock to 12 o'clock”, the uttered content is stored in the start time and the end time among the input items in the scheduler service illustrated in FIG. 2A. In this case, a weighting factor “3” of the start time+a weighting factor “3” of the end time=“6” becomes the score of the scheduler service. Meanwhile, in the navigation (route search) service illustrated in FIG. 2B, the uttered content is stored in the departure time or the arrival time among the input items. In this case, the weighting factor “3” of the departure time or the arrival time becomes a score of the navigation (route search) service.

For example, when the uttered content of the user is “to Nagoya Station at 12 o'clock”, the uttered content is stored in the end time and the place among the input items in the scheduler service illustrated in FIG. 2A. In this case, a weighting factor “3” of the end time+a weighting factor “1” of the place=“4” becomes a score of the scheduler service. Meanwhile, in the navigation (route search) service illustrated in FIG. 2B, the uttered content is stored in the arrival time and the destination among the input items. In this case, a weighting factor “3” of the arrival time+a weighting factor “3” of the destination=“6” becomes the score of the navigation (route search) service.

When there is an input item in which the uttered content is not yet stored in a service having the highest score calculated by the calculation unit 23, the request unit 24 illustrated in FIG. 1 requests the user to utter the input item. Hereinafter, a procedure for requesting the user to utter the input item will be specifically described.

For example, in a case where the service having the highest score is the scheduler service, when the uttered content is not yet stored in the purpose and the place, a question “Where do you want to go (place) and what do you want to do (purpose)?” is given to the user. When the service with the highest score is the navigation (route search), when the uttered content is not yet stored in the departure place, a question “Where do you plan to depart from?” is given to the user.

When there is a service in which the uttered content is stored in all of the input items, the providing unit 25 provides the service to the user. For example, when the uttered content is stored in all the input items of the scheduler service, a schedule is registered in the scheduler of the user. Meanwhile, when the uttered content is stored in all of the input items of the navigation (route search) service, a navigation screen for guiding the information terminal 1 of the user to a travel route is displayed.

Here, when the uttered content is stored in all of the input items that are indispensable items, the service may be provided to the user. For example, when the uttered content is stored in the start time and the end time which are indispensable items of the scheduler service, the schedule may be registered in the scheduler of the user. When the uttered content is stored in the arrival time and the destination which are indispensable items of the navigation (route search) service, the navigation screen for guidance on the travel route may be displayed on the information terminal 1 of the user.

As described above, according to the service providing system 100 in the embodiment, the computer can store a plurality of input items needed when services based on voice recognition are provided and weighting factors for the input items, for each service, specify the input items in which uttered content is stored, based on the content uttered by the user, store the uttered content in the specified input item, calculate a score of each service based on all the input items in which the uttered content is stored and the weighting factors corresponding to the input items, and request a user to utter the input item when there is the input item in which the uttered content is not yet stored in the service having the highest calculated score. Furthermore, in the service providing system 100 in the embodiment, the computer may be configured to provide the service to the user when there is the service in which the uttered content is stored in all of the input items.

Further, in the service providing system 100 according to the embodiment, the computer may store an indication indicating whether or not the input item is an indispensable item in association with the input item, and provide the service in which the uttered content is stored in all of the input items which are the indispensable items, to the user.

As described above, according to the service providing system 100 in the embodiment, it is possible to provide a service desired by the user, which is led by a system side, while specifying insufficient items based on the uttered content of the user and requesting the user to utter the insufficient items. Therefore, it is possible to further improve convenience for the user.

The present disclosure is not limited to the embodiment described above and can be implemented in various other forms without departing from the gist of the present disclosure. Accordingly, the embodiment described above is merely illustrative in all respects and is not to be construed as restrictive. For example, the respective processing steps described above can be optionally changed in an order or executed in parallel as long as there is no inconsistency in processing content.

The service providing device 2 in the embodiment described above includes the specifying unit 21, the storage unit 22, the calculation unit 23, the request unit 24 and the providing unit 25 as a functional configuration, but the present disclosure is not limited thereto, and any function can be appropriately deleted or added according to needs. For example, the providing unit 25 may be incorporated in a device different from the service providing device 2, or a voice recognition function of the voice recognition device 3 may be incorporated in the service providing device 2.

What is claimed is:

1. A service providing device comprising a computer configured to
store a plurality of input items needed when services based on voice recognition are provided and weighting factors for the input items, for each service,
specify the input items in which uttered content is stored, based on the content uttered by a user,
store the uttered content in the input item specified,
calculate a score of each service based on all the input items in which the uttered content is stored and the weighting factors corresponding to the input items, and
request a user to utter the input item when there is the input item in which the uttered content is not yet stored in the service having a highest calculated score.

2. The service providing device according to claim 1, wherein the computer is configured to provide the service to the user when there is the service which the uttered content is stored in all of the input items.

3. The service providing device according to claim 2, wherein the computer is configured to
store an indication indicating whether or not the input item is an indispensable item in association with the input item, and
provide the service in which the uttered content is stored in all of the input items which are the indispensable items, to the user.

4. A computer-readable non-transitory storage medium storing a service providing program, the service providing program causing a computer to
store a plurality of input items needed when services based on voice recognition are provided and weighting factors for the input items, for each service,
specify the input items in which uttered content is stored, based on the content uttered by a user,
store the uttered content in the input item specified,
calculate a score of each service based on all the input items in which the uttered content is stored and the weighting factors corresponding to the input items, and
request a user to utter the input item when there is the input item in which the uttered content is not yet stored in the service having a highest calculated score.
